(19) United States
(12) Patent Application Publication
(10) Pub. No.: US 2008/0168819 A1
(43) Pub. Date: Jul. 17, 2008

(54) Closing device and closing method

(75) Inventor: Naomasa Tsuda, Tokyo (JP)

Correspondence Address: RABIN & Berdo, PC, 1101 14TH STREET, NW, SUITE 500, WASHINGTON, DC, 20005, US

(73) Assignee: KAYABA INDUSTRY CO., LTD., Tokyo (JP)

(21) Appl. No.: 12/007,863

(22) Filed: Jan. 16, 2008

(30) Foreign Application Priority Data
Jan. 17, 2007 (JP) 2007-007806

(51) Int. Cl. B21J 7/16; F16L 13/14

(52) U.S. Cl. 72/402; 285/382

(57) ABSTRACT

A closing device (100) closes an open end portion of a tubular body (1) using a die (2). The closing device (100) includes a core (3) that is inserted into the tubular body (1) and closes the open end portion of the tubular body (1) on the opposite side of the die (2), first heating device (53) that heats the tubular body (1) during a closing process and are also capable of heating the core (3), and second heating device (54) that heats the die (2). At the start of the closing process, the core (3) and the die (2) are preheated by the first heating device (53) and the second heating device (54) respectively, and the closing process is begun when the temperature difference between the tubular body (1) and the core (3) and die (2) is small.

### TECHNICAL FIELD OF THE INVENTION

This invention relates to a closing device and a closing method.

### DESCRIPTION OF RELATED ART

A closing process for closing an open end portion of a pipe between a die and a core by heating and rotating the pipe and then pressing the die against the pipe open end portion while the core is inserted into the pipe is known as a method of closing an open end portion of a metallic pipe (see JP 2005-342725A).

### SUMMARY OF THE INVENTION

When pipes are processed continuously in a closing device, the heat that is applied to the pipes causes the temperature of the die and core to rise, and therefore the heat applied to the pipe is unlikely to be transferred to the die and core.

However, at the beginning of the closing process, the die and core are cool, and therefore, if the process is begun in this state, the heat of the pipe is transferred to the die and core, making the pipe closing process unstable.

As a result, it is sometimes necessary to discard several pipes manufactured immediately after the start of the closing process.

This invention has been designed in consideration of this problem, and it is an object thereof to provide a closing device and a closing method with which processing can be performed with stability immediately after the start of the processing.

In order to achieve above object, this invention provides a closing device that closes an open end portion of a tubular body using a die by moving the rotating tubular body and the die relative to each other. The closing device comprises first heating device that heats the tubular body during a closing process, and second heating device that heats the die, wherein the die is preheated by the second heating device at the start of the closing process, and the closing process is begun when a temperature difference between the die and the tubular body is small.

### BRIEF DESCRIPTION OF THE DRAWINGS

FIG. 1 is a plan view showing a closing device 100 according to an embodiment of this invention.

FIG. 2 is a partially enlarged view showing the closing device 100 in a standby state prior to processing.

FIGS. 3A and 3B are views showing procedures of a preliminary heating process performed on a die and a core.

FIGS. 4A to 4D are views showing procedures of the closing process.

### PREFERRED EMBODIMENT OF THE INVENTION

An embodiment of this invention will be described below with reference to the drawings.

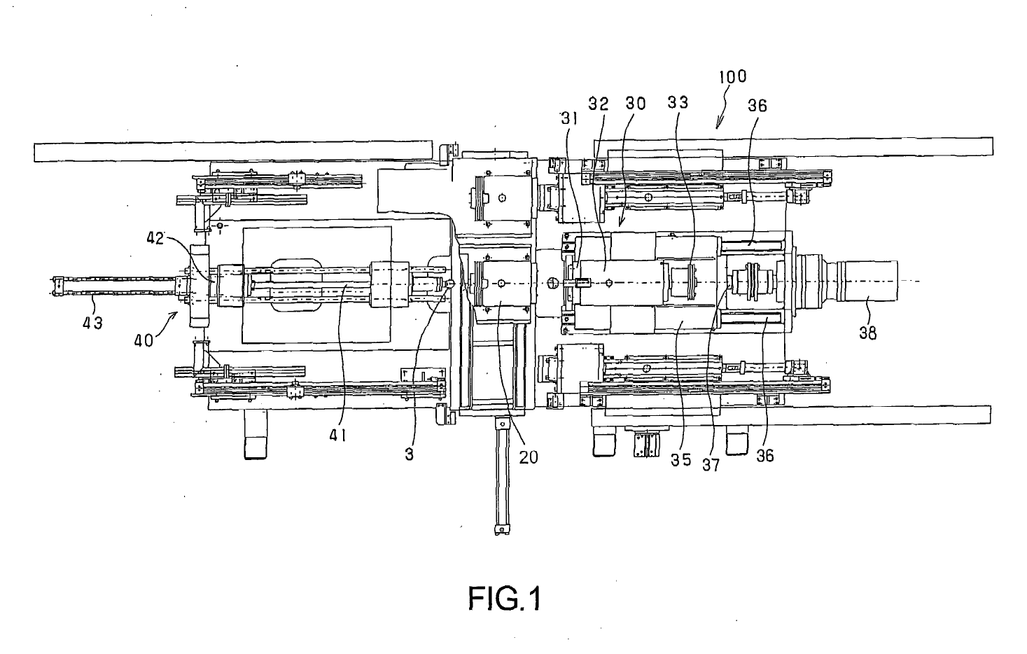

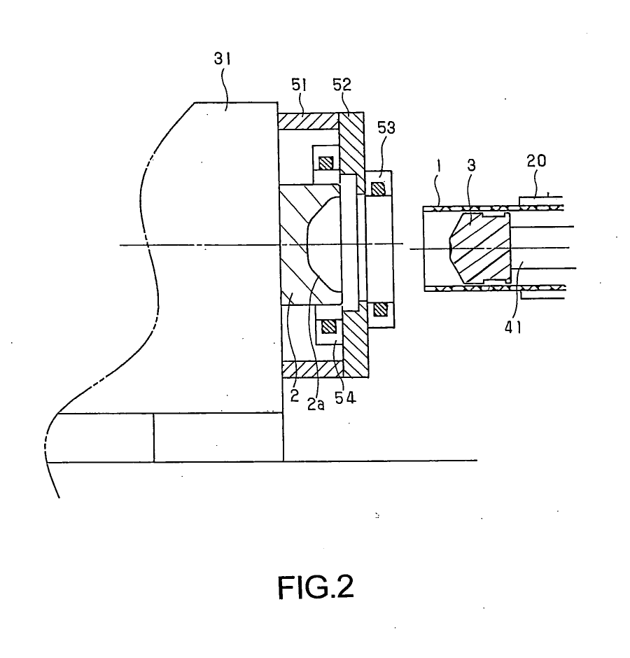

Referring to FIGS. 1 and 2, a closing device 100 serving as an embodiment of this invention will be described.

First, the overall structure of the closing device 100 will be described.

The closing device 100 is a device for forming a pipe having a bottom by closing an open end portion of a pipe 1 constituted by a metallic tubular body. The closing device 100 closes the pipe open end portion by pressing a die 2 against the pipe open end while heating and rotating the pipe 1, thereby subjecting the pipe 1 to plastic deformation.

An outer peripheral surface of the pipe 1 is gripped by a chuck spindle 20 disposed near a central portion of the closing device 100. The chuck spindle 20 rotates (spins) the gripped pipe 1 about its axis.

A die 2 has a die cavity 2a in the shape of a bottom portion formed on the pipe 1 following a closing process, and is disposed so as to face the pipe 1.

The die 2 can be rotated (spun) and moved in an axial direction of the pipe 1 by a die driving mechanism 30.

The die driving mechanism 30 comprises a die support base 31 that supports a shaft (not shown), having an end portion to which the die 2 is attached, rotatably via a bearing, a motor 32 that rotates the die 2 via the shaft, a power transmission mechanism 33 that transmits the rotation of the motor 32 to the shaft, and a one-way clutch (not shown) that inputs torque into the shaft from the power transmission mechanism 33 and blocks torque input into the power transmission mechanism 33 from the shaft.

By means of these constitutions in the die driving mechanism 30, the die 2 rotates when the motor 32 is driven, and when the die 2 is pressed against the pipe 1, which rotates at a higher speed than the die 2, the die 2 rotates in subordination to the pipe 1 due to the action of the one-way clutch.

The die driving mechanism 30 further comprises a sliding table 35 carrying the die support base 31, a pair of guide rails 36 that extend in the axial direction of the pipe 1 and guide the sliding table 35, and a motor 38 having an output shaft to which a ball screw 37 screwed to the sliding table 35 is connected.

By means of these constitutions in the die driving mechanism 30, the sliding table 35 moves along the guide rails 36 when the motor 38 is driven, whereby the die 2 can move in a direction toward the pipe 1 or a direction away from the pipe 1. Hence, by driving the motor 38, the die 2 can be pressed against the open end portion of the pipe 1.

A core 3 disposed in a hollow portion of the pipe 1 and capable of moving relative to the pipe 1, which closes the open end portion of the pipe 1 on the opposite side of the die 2, is disposed to the rear of the chuck spindle 20. A tip end of the core 3 takes a spherical form defining a rear surface shape of the bottom portion to be formed on the pipe 1.

The core 3 is capable of rotating (spinning) and can be moved in the axial direction of the pipe 1 by a core driving mechanism 40.

The core driving mechanism 40 comprises a rod 41 connected to a base end portion of the core 3 and extending coaxially with the pipe 1, a support 42 that supports a base end side of the rod 41 rotatably via a bearing, and a hydraulic cylinder 43 that moves the support 42 in the axial direction of the pipe 1.

When the hydraulic cylinder 43 performs an expansion/contraction operation, the core 3 on the tip end of the rod 41 is inserted into the hollow portion of the pipe 1. Further, when the core 3 comes into contact with the rotating pipe 1 during the closing process, the core 3 rotates (spins) in subordination to the pipe 1.

Next, referring to FIG. 2, a structure on the periphery of the die 2 will be described.

A ring-shaped bracket 52 is attached to a tip end of the die support base 31 via a tubular body 51. The die 2 is disposed inside the tubular body 51, and the pipe 1 is capable of penetrating an inner periphery of the bracket 52 to come into contact with the die 2.

A high-frequency induction heating coil 53 serving as first heating device is attached in ring form to a front surface (the pipe 1 side) of the bracket 52. The high-frequency induction heating coil 53 heats both the pipe 1 and the core 3.

Further, a high-frequency induction heating coil 54 serving as second heating device is attached in ring form to a rear surface (the die 2 side) of the bracket 52 so as to surround the die 2. The high-frequency induction heating coil 54 heats the die 2.

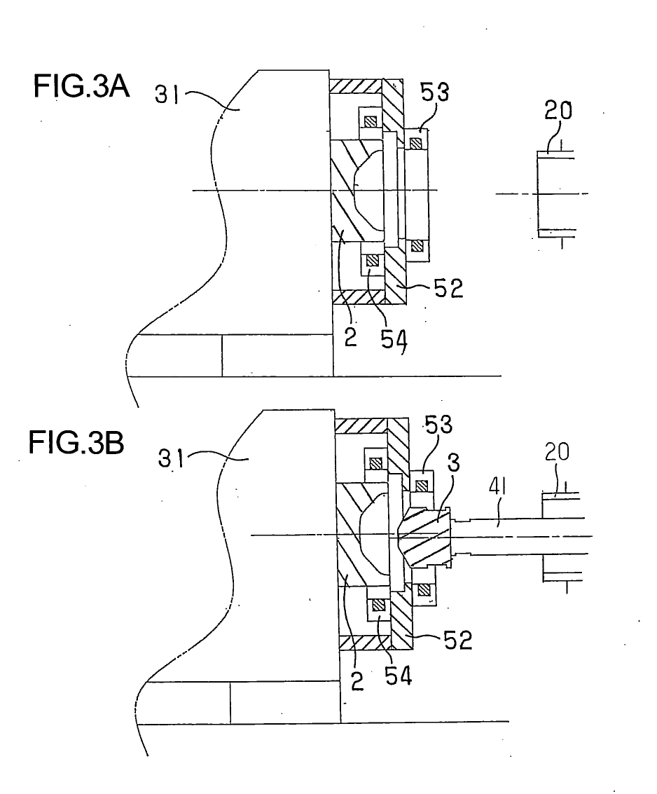

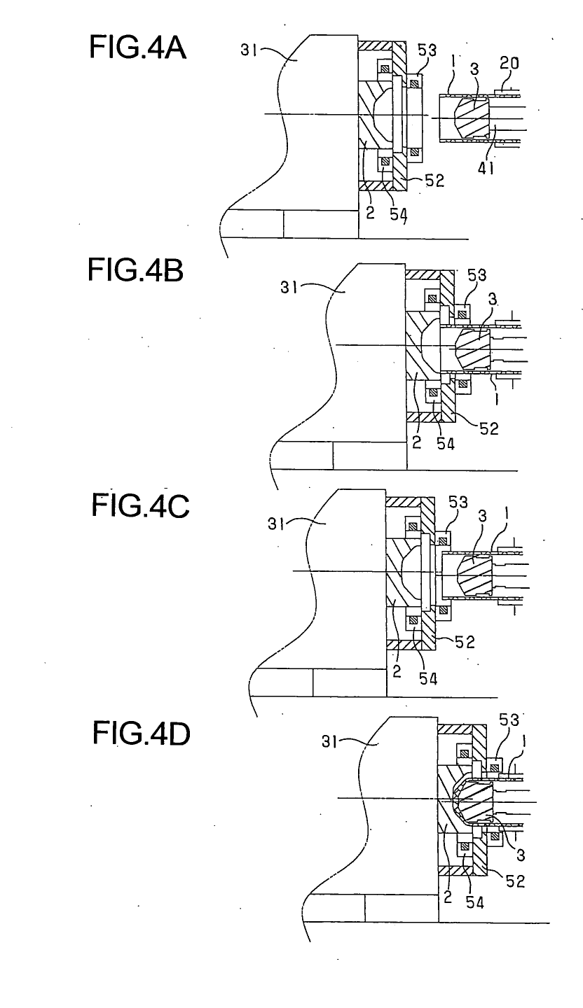

Next, referring to FIGS. 3 and 4, each step of a closing method employing the closing device 100 will be described in sequence. FIG. 3 is a view showing procedures of a preliminary heating process performed on the die 2 and the core 3, and FIG. 4 is a view showing procedures of the closing process.

The operations of the various members to be described below are controlled automatically by a controller (not shown) installed in the closing device 100. It should be noted that the processing procedures to be described below are procedures executed when processing is begun after the closing device has been halted for a fixed time period.

First, preliminary heating is performed on the die 2 in the state shown in FIG. 3A. Primary heating of the die 2 is performed by electrifying the high-frequency induction heating coil 54.

Next, as shown in FIG. 3B, the core 3 is caused to advance by driving the core driving mechanism 40 until the core 3 protrudes from an open end of the chuck spindle 20 and is disposed inside the high-frequency induction heating coil 53. In this state, preliminary heating is performed on the core 3. Preliminary heating of the core 3 is performed by electrifying the high-frequency induction heating coil 53.

In this manner, the die 2 and the core 3 are subjected to preliminary heating. When performed through high-frequency induction heating, preliminary heating can be achieved in a short time period of approximately 1 or 2 minutes in relation to the die 2 and approximately 1 or 2 seconds in relation to the core 3.

As shown in FIG. 4A, when preliminary heating of the die 2 and core 3 is complete, the pipe 1 is gripped by the chuck spindle 20 and the core 3 is inserted into the hollow portion of the pipe 1. Then, by driving the chuck spindle 20 and the die driving mechanism 30, the pipe 1 and the die 2 are rotated. The state shown in FIG. 4A corresponds to a standby position before the start of the process. It should be noted that the core 3 is held in this position from the start to the end of the process.

Next, as shown in FIG. 4B, the die support base 31 and the bracket 52 are caused to advance by driving the die driving mechanism 30. As a result, the high-frequency induction heating coil 53 is disposed on the outer periphery of the pipe 1. The state shown in FIG. 4B corresponds to a heating start position for starting to heat the pipe 1, and heating of the pipe 1 is begun by electrifying the high-frequency induction heating coil 53.

Then, by driving the die driving mechanism 30, the high-frequency induction heating coil 53 is caused to retreat along the pipe 1, thereby heating the pipe 1. The state shown in FIG. 4C corresponds to a heating end position in which heating of the pipe 1 ends. Thus, both the core 3 and the pipe 1 are heated by the high-frequency induction heating coil 53.

Next, closing is performed on the pipe 1. As shown in FIG. 4D, the die 2 is caused to advance toward the pipe 1 by driving the die driving mechanism 30 until the die 2 is pressed against the open end portion of the pipe 1.

As a result, the end portion of the heated pipe 1 is subjected to plastic deformation in accordance with the shape of the die cavity in the die 2, and comes into contact with the core 3 inserted into the pipe 1. Thus, the pipe 1 is processed between the die 2 and the core 3 such that the open end portion of the pipe 1 is closed and formed into a bottom portion. In this manner, closing is performed on the pipe 1.

In this process, the die 2 and core 3 are preheated, and therefore the heat that is applied to the pipe 1 is unlikely to be transferred to the die 2 and core 3. Hence, during the process, the pipe 1 exhibits a favorable deformation characteristic. If the die 2 and core 3 are not preheated during processing of the pipe 1, a large temperature difference occurs between the pipe 1 and the die 2 and core 3. As a result, the heat applied to the pipe 1 is transferred to the die 2 and core 3 during the process, and in the worst-case scenario, the bottom portion is not formed, leaving a hole in the pipe 1.

According to the embodiment described above, closing can be begun in a state where the temperature difference between the pipe 1 and the die 2 and core 3 is small by preheating the die 2 and core 3 at the start of the closing process, and therefore stable processing can be performed immediately after the beginning of the closing process. Hence, the need to discard the pipes 1 that are manufactured at the beginning of the closing process is eliminated, leading to an improvement in production efficiency.

It should be noted that the procedures described above are procedures executed when processing is begun after the closing device has been halted for a fixed time period, or in other words when the die 2 and core 3 are cool, and once the temperature of the die 2 and core 3 has risen, the closing process shown in FIG. 4 is repeated omitting the preliminary heating process shown in FIG. 3.

This invention is not limited to the embodiment described above, and may be subjected to various modifications within the scope of the technical spirit thereof.

For example, in the embodiment described above, processing is performed using the die 2 and the core 3, but the processing may be performed using the die 2 alone.

Further, in the embodiment described above, the die 2 is moved relative to the pipe 1, but the processing may be performed by moving the pipe 1 relative to the die 2. In other words, the pipe 1 can be processed as long as the pipe 1 and the die 2 can be moved relative to each other.

Further, in the embodiment described above, two high-frequency induction heating coils (53, 54) are provided as the heating device, but the pipe 1, the die 2 and the core 3 may all be heated by a single high-frequency induction heating coil. For example, when the pipe 1, die 2 and core 3 are heated by the high-frequency induction heating coil 53 attached to the front surface of the bracket 52 alone, heating is performed on the pipe 1 and core 3 in the manner described above, and the die 2 can be heated by the high-frequency induction heating coil 53 by making the die 2 capable of advancing and retreating relative to the die support base 31.

Furthermore, in the embodiment described above, high-frequency induction heating is used as the heating device, but any device that is capable of applying heat, such as a burner or an industrial drier, may be used as the heating device for heating the pipe 1, die 2 and core 3.

1. A closing device that closes an open end portion of a tubular body using a die by moving the rotating tubular body and the die relative to each other, comprising:
first heating device that heats the tubular body during a closing process; and
second heating device that heats the die,
wherein the die is preheated by the second heating device at the start of the closing process, and the closing process is begun when a temperature difference between the die and the tubular body is small.

2. The closing device as defined in claim 1, further comprising a core that is inserted into the tubular body and closes the open end portion of the tubular body on an opposite side of the die,
wherein the first heating device is also capable of heating the core, and
the core and the die are preheated by the first heating device and the second heating device respectively at the start of the closing process, and the closing process is begun when a temperature difference between the tubular body and the core and die is small.

3. The closing device as defined in claim 2, further comprising a core moving mechanism that moves the core in an axial direction of the tubular body,
wherein the first heating device is a high-frequency induction heating coil, and
the core is disposed inside the high-frequency induction heating coil by the core moving mechanism, where high-frequency induction heating is applied thereto.

4. The closing device as defined in claim 3, wherein the first heating device and the second heating device are identical heating device.

5. A closing method in which an open end portion of a tubular body is closed using a die by moving the rotating tubular body and the die relative to each other, comprising:
preheating the die at the start of a closing process, and
subsequently heating the tubular body and performing the closing process.

6. The closing method as defined in claim 5, comprising:
preheating the die and preheating a core inserted into the tubular body at the start of the closing process, and
subsequently heating the tubular body and performing the closing process to close the open end portion of the tubular body between the die and the core.

7. The closing method as defined in claim 6, wherein preheating of the core is performed by moving the core in an axial direction of the tubular body such that the core is disposed in a high-frequency induction heating coil, and electrifying the high-frequency induction heating coil.

8. The closing device as defined in claim 2, wherein the first heating device and the second heating device are identical heating device.

9. The closing device as defined in claim 1, wherein the first heating device and the second heating device are identical heating device.
